(19) United States
(12) Patent Application Publication
(10) Pub. No.: US 2012/0078790 A1
(43) Pub. Date: Mar. 29, 2012

(54) REAL-TIME INTERCHANGE FEE ESTIMATION

(76) Inventors: Matthew R. Ornce, Wilmington, DE (US); Jason J. Gwynn, Newark, DE (US); Steve H. Pile, Phoenix, AZ (US); Kent R. Glenn, Buckeye, AZ (US)

(21) Appl. No.: 13/158,074

(22) Filed: Jun. 10, 2011

Related U.S. Application Data
(60) Provisional application No. 61/353,981, filed on Jun. 11, 2010.

(51) Int. Cl. G06Q 20/08; G06Q 20/40

(52) U.S. Cl. 705/44; 705/39

(57) ABSTRACT

Few merchants are in a position to understand how changes to processes or procedures may alter the issuer risk and/or subsequent transaction processing costs. Merchants would prefer to be provided with estimated Interchange fees associated with a financial transaction in real-time. To provide a merchant with an estimated Interchange fee in real-time, a financial transaction request may be received from the merchant and used to determine the estimated Interchange fee. The estimated Interchange fee may then be transmitted to a merchant in real-time. The estimated Interchange fee may be representative of an actual Interchange fee associated with a financial transaction. Estimated Interchange fees may be provided as part of an authorization or settlement processing method.

### CROSS REFERENCE TO RELATED APPLICATIONS

This application claims the benefit of U.S. Provisional Patent Application Ser. No. 61/353,981, filed Jun. 11, 2010, the contents of which are hereby incorporated by reference herein.

### TECHNICAL FIELD

This application relates to providing estimated Interchange fees associated with a financial transaction.

### BACKGROUND

Interchange fees are the fees that a merchant's credit card processing bank (the “acquiring bank,” or “acquirer”) pays a consumer's bank (the card “issuing bank,” or “issuer”) when the merchant accepts a credit or debit card. The issuer charges these fees to cover the cost of offering credit, paying for billing, and bearing the financial risk for the transaction, as well as their profit.

The Interchange fees may be based on a complex combination of Interchange categories that depend on the brand and type of card, the specific information included in the transaction, how and when the transaction was performed, the merchant's size and industry type, as well as other factors. Because of the complexity of the Interchange fee system, few merchants are in a position to understand how slight changes to processes or procedures may significantly alter the issuer risk and subsequent transaction processing costs.

### SUMMARY

Various techniques for providing a merchant with an estimated Interchange fee are described herein. In an example embodiment a method is described for providing a merchant with an estimated Interchange fee in real-time. As described herein, a financial transaction request may be received from a merchant and an estimated Interchange fee may be determined in real-time based on the received financial transaction request. The estimated Interchange fee may be representative of an actual Interchange fee associated with a financial transaction between the merchant and a consumer. After the estimated Interchange fee is determined, it may be sent to the merchant, such as in real-time for example. The merchant may use the estimated Interchange fee to change various business techniques that may have an impact on the actual Interchange fee.

According to an embodiment, the estimated Interchange fee may be sent to the merchant during an authorization process associated with a financial transaction.

According to another embodiment, an updated Interchange fee may be sent to the merchant after a settlement file has been received from the merchant. The settlement file may include data associated with a financial transaction for example.

According to another embodiment, a computer-readable storage medium is described herein that may be used to provide a merchant with an estimated Interchange fee. The computer readable storage medium may have computer executable instructions stored thereon that are configured to cause a processor to perform various steps when executed. For example, the computer executable instructions may be configured to cause a processor to receive a financial transaction request from a merchant and determine an estimated Interchange fee in real-time based on the received financial transaction request. The estimated Interchange fee may be representative of an actual Interchange fee associated with a financial transaction. The computer executable instructions may be further configured to cause the processor to send the estimated Interchange fee to the merchant.

This Summary is provided to introduce a selection of concepts in a simplified form that are further described below the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

Exemplary embodiments will be described in connection with the associated figures, of which:

FIG. 1 is a diagram illustrating an exemplary method for processing a financial transaction;

FIG. 2 is a diagram illustrating an exemplary authorization process;

FIG. 3 is a diagram illustrating an embodiment of an authorization process in which a merchant is provided with an estimated Interchange fee in real-time;

FIG. 4 is a diagram illustrating an exemplary batch settlement process;

FIG. 5 is a diagram illustrating an embodiment of a batch settlement process for providing a merchant with an estimated Interchange fee; and

FIG. 6 is a block diagram of one embodiment of a computer system in which aspects of the disclosed systems and methods may be embodied.

### DETAILED DESCRIPTION OF ILLUSTRATIVE EMBODIMENTS

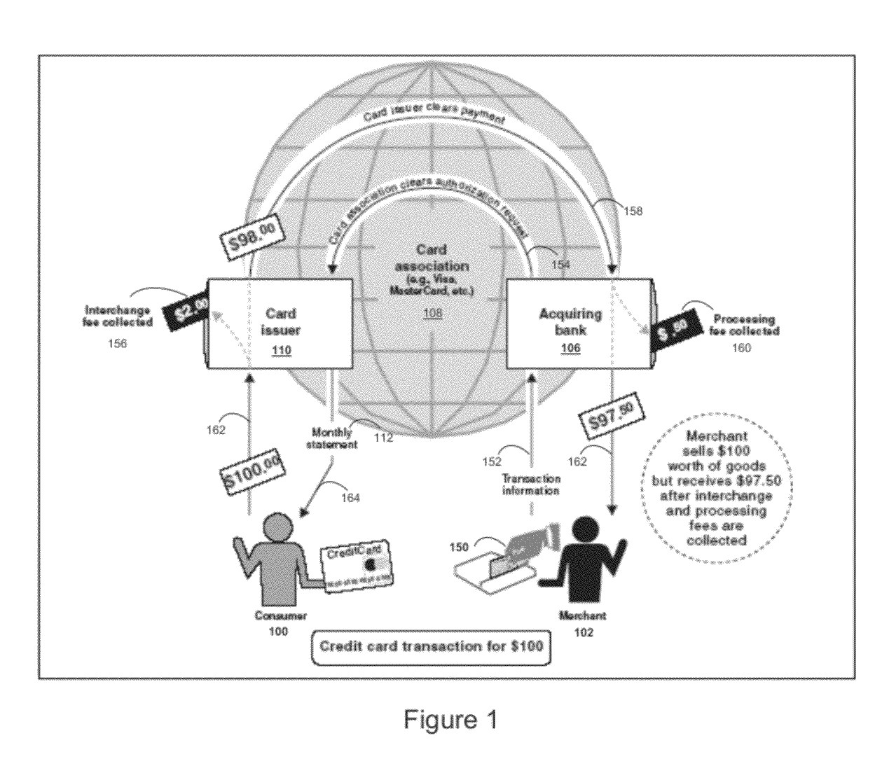

A detailed description of illustrative embodiments will now be described with reference to FIGS. 1-6. Although this description provides a detailed example of possible implementations, it should be noted that the details are intended to be exemplary and in no way limit the scope of the application.

Interchange fees may be fees that a merchant's credit card processing bank (the “acquiring bank,” or “acquirer”) may pay a consumer's bank (the card “issuing bank,” or “issuer”) when the merchant accepts a credit or debit card transaction. The issuer may charge these fees to cover the cost of offering credit, paying for billing, and/or bearing the financial risk for the transaction, as well as their profit.

The issuer may deduct these Interchange fees from the total transaction amount, and may send the balance to the acquiring bank. The acquiring bank may pay the merchant the amount of the transaction less Interchange, and/or less any other acquiring and/or processing fees. These other fees may be less than the Interchange fees for example.

In an example embodiment, as described herein, merchants may be provided with the estimated Interchange fees associated with a financial transaction in real-time. For example, the estimated Interchange fees may be provided with an authorization response. Based on the estimated Interchange fees, merchants may be able to quickly react and/or influence the actual Interchange fee sooner, rather than waiting for a month-end processing statement in order to react for example. The estimated Interchange fees associated with a financial transaction may be used, for example, to identify certain transaction data fields and/or their contents that may be added, corrected, and/or deleted, identify changes to processing methods (e.g., when settlements are performed in relationship to their corresponding authorizations), identify changes to business practices (e.g., cashier training), and/or request merchant setup changes (e.g., correcting an MCC code).

In an example embodiment, to provide a merchant with an estimated Interchange fee in real-time, a financial transaction request may be received from a merchant. An estimated Interchange fee may be determined in real-time based on the received financial transaction request. The estimated Interchange fee may be representative of an actual Interchange fee associated with a financial transaction. The estimated Interchange fee may be sent to the merchant.

In an example embodiment, a batch settlement process may be used to provide a merchant with an estimated Interchange fee. In an embodiment, the merchant may review transaction and/or Interchange qualification and/or associated fee information through a Web Portal. The Interchange information may include information regarding an Interchange category downgrade for a transaction and/or reasons for the downgrade. If this information is reviewed prior to settlement, the merchant may have the opportunity to supply additional information for unsettled transactions to improve the estimated Interchange qualification and associated fees. Also, regardless of when the merchant reviews the information, the merchant may have the opportunity to change processor setup information or make changes to its own business practices in order to improve the estimated Interchange qualification and the associated fees.

FIGS. 1-5 describe exemplary processes for determining actual and/or estimated Interchange fees and which may include entities such as a Consumer 100, a Merchant 102, a Processor 104, an Acquiring Bank 106, Card Network 108, Issuing Bank 110, and/or Merchant Bank 118.

A Consumer 100 may be a person or an entity that may be attempting to purchase goods and/or services using a credit and/or debit card.

A Merchant 102 may be a person or an entity that may be attempting to sell goods and/or services to a Consumer 100.

A Processor 104 may connect a Merchant 102 to the Card Network 108 by taking the authorization data from the Merchant 102 and authorizing sales with the Issuing Bank 110 and/or settling funds through the Card Network's 108 Interchange system.

An Acquiring Bank 106 may be a financial institution that may hold the merchant processing contract and/or may be ultimately responsible for the risk of the transactions. The Acquiring Bank 106 may be directly responsible for Card Network 108 fees and/or fines.

Card Network 108 may include a Card Network, such as a Visa, MasterCard, Discover card networks, and/or the like. Card Network 108 may run payment networks that connect the Processors 104 with that brand's Issuing Bank 110. Card Network 108 may manage the collection and/or distribution of data and/or fees between them.

Issuing Bank 110 may include financial institutions that may issue the card plastics to Consumer 100. Issuing Bank 110 may manage Consumer's 100 account balance and/or standing, and/or may distribute credit card statements 112.

A Merchant Bank 118 may be a financial institution where the Merchant 102 may maintain their business's account.

FIG. 1 illustrates a method for processing a transaction and/or charging its Interchange and/or acquiring fees. As illustrated in FIG. 1, Consumer 100 may use a credit card and/or debit card to purchase goods or services (e.g., in the amount of one hundred dollars) from Merchant 102. At 150, the Merchant 102 may take financial transaction information from Consumer 100. For example, the financial transaction information may include credit card and/or debit card information of the Consumer 100 and/or an authorization request for the financial transaction. Merchant 102 may send the transaction information to Acquiring Bank 106 at 152. The Acquiring Bank 106 may send an authorization request to Card Issuer 110 via Card Association 108 (e.g., Visa, MasterCard, etc.). For example, the Card Association 108 may clear the authorization request with Card Issuer 110 at 154. Consumer 100 may receive a monthly statement 112 at 164. At 162, Consumer 100 may pay the one hundred dollars for the goods or services purchased from the Merchant 102 using the credit and/or debit card. The Card Issuer 110 may collect an Interchange fee (e.g., a two dollar Interchange fee) at 156. The Card Issuer 110 may send the Consumer's 100 payment, less the collected Interchange fees to the Acquiring Bank 106 at 158. The Acquiring Bank may collect processing fees (e.g., fifty cents) at 160. At 162, the Acquiring Bank 106 may send the Consumer's 100 payment less the Interchange fees and processing fees to the Merchant 102.

Interchange fees may be computed by a computer system by applying a percentage rate to the transaction total and/or a per transaction fee, based on the Interchange category for which the transaction qualified. For example, these fees may range from 1% to 3% and/or $0.10 to $1.50 per transaction.

Interchange fees may be based on a complex combination of Interchange categories that may depend on the brand and/or type of card, the specific information included in the transaction, how and/or when the transaction was performed, the merchant's size and/or industry type, as well as other factors for example. For a transaction to qualify for an Interchange category, certain qualification criteria may be analyzed. The qualification criteria may be established by the card brands and/or the debit networks. Transactions that may not qualify for the intended Interchange category may be downgraded to a more costly Interchange category to offset the issuer's increased risk.

In some very low dollar value transactions, the Interchange and/or other acquiring and/or processing fees may exceed the transaction dollar value. As the dollar value of the transaction increases, the Interchange basis points may erode merchant profit. Unfortunately for the merchant, they may have to accept these transactions as a cost of doing business to retain the privilege of accepting credit and/or debit card transactions.

The Interchange fees may be computed by a computer system offline, such as well after a real-time authorization request for example, and/or prior to batch processes that move money from the issuer to the merchant for example. Additionally, the fees may be communicated to the merchants in a summarized monthly statement. This may prohibit the merchant from understanding why individual transactions downgraded to higher-cost Interchange categories and/or reacting quickly—if at all—to changes in Interchange fees.

In some cases, the merchant may be able to change business processes to minimize the likelihood of downgraded Interchange category costs. For instance, swiping the card may lead to more favorable rates, but if the equipment is broken or the cashiers are improperly trained, transactions may be key-entered. Key-entered transactions may have a higher Interchange fee because they may have a higher risk associated with them. For example, there may be no guarantee that the card is present at the point of sale as in the case of a swiped transaction, so there may be a higher likelihood that the transaction may be charged back, which may cause the Issuer to return the funds to the consumer.

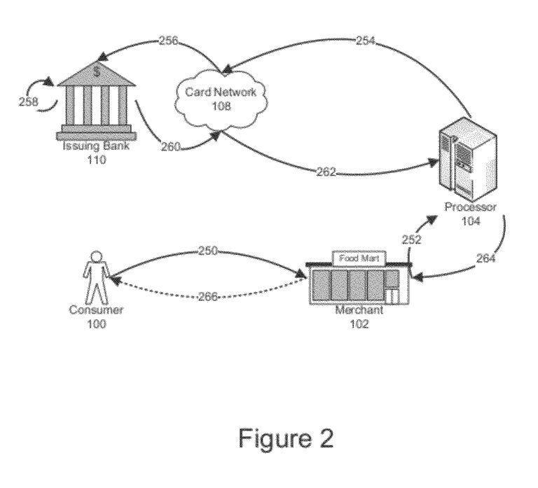

FIG. 2 illustrates an example of an authorization process for a financial transaction. As shown in FIG. 2, the process may involve a Consumer 100, a Merchant 102, a Processor 104, Card Network 108, and/or Issuing Bank 110. While these entities are identified in the Figures, it is understood that the processes described below may be carried out by computers or computer systems operated by these entities, which computers and computer systems may communicate via wired or wireless communication networks, including, for example, the Internet or other networks.

To begin a financial transaction, a Consumer 100 may interact with a Merchant 102, such as by providing a credit card and/or debit card to the Merchant 102 at 250. For example, a Consumer 100 may interact with a Merchant 102 face to face (e.g., Retail), over the phone or through the mail (e.g., Mail Order/Telephone Order, MOTO), on the Internet (e.g., E-Commerce), or the like. In one example, the Consumer 100 may swipe his or her credit card and/or debit card, or have the card swiped, by a card reader device at the Merchant's point of sale.

Regardless of the manner of interaction, if the Consumer 100 pays by credit and/or debit card, the Merchant 102 may contact the Consumer's 100 card's Issuing Bank 110 to procure a real-time authorization request. For example, the Merchant 102 may send, via for example, an electronic transmission, an authorization request to a Processor 104 at 252. This real-time authorization request may be facilitated by the Processor 104, which may operate as the intermediary between the Merchant 102 and the Card Network 108 and/or the Issuing Bank 110. The Processor 104 may also operate with the Issuing Bank 110 directly, such as in the case where the credit card is an American Express card for example.

The Processor 104 may send the authorization request, via an electronic transmission, to Card Network 108 at 254. At 256, the Card Network 108 may send the authorization request to the Issuing Bank 110. For example, the Card Network 108, if applicable, may pass the transaction request to the Issuing Bank 110 for that card which may validate the request, and may approve or decline it. At 258, a computer system operating at the Issuing Bank 110 may approve or decline the request. Regardless of the decision, the Issuing Bank 110 may send the authorization request response back through the Card Network 108 at 260, as applicable, and the Card Network 108 may send the authorization request response to the Processor 104 at 262. At 264, the Processor 104 may send the authorization request response to the Merchant 102, and, if approved, the Consumer 100 may receive goods and/or services from Merchant 102 at 266.

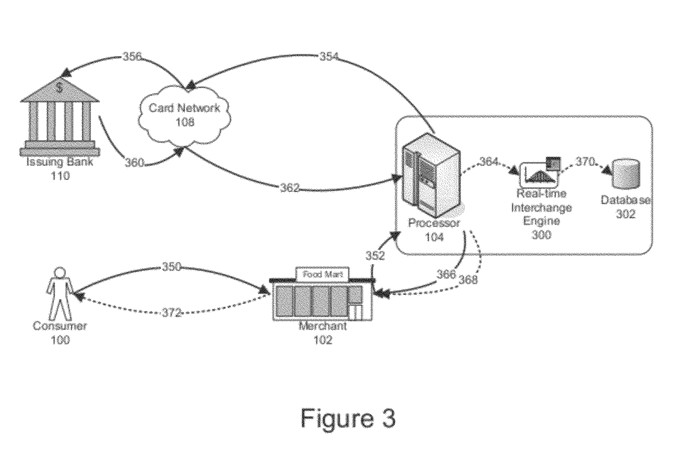

FIG. 3 illustrates an example embodiment of an authorization process in which a merchant may be provided with an estimated Interchange fee in real-time.

In the example embodiment, Consumer 100 may provide a financial transaction request (e.g., an authorization request, a consumer's credit and/or debit card information, etc.) to Merchant 102 at 350. At 352, Merchant 102 may send the financial transaction request to Processor 104. The Processor 104 may send an authorization request to Card Network 108 at 354. At 356, Card Network 108 may send the authorization request to Issuing Bank 110. Alternatively, the Processor 104 may send the authorization request directly to the Issuing Bank 110. The Issuing Bank 110 may approve or decline the authorization request. The Issuing Bank 110 may send an authorization request response to the Card Network 108 at 360. At 362, the Card Network 108 may send the authorization request response to the Processor 104. Alternatively, the authorization request response may be sent directly from the Issuing Bank 110 to the Processor 104.

The Processor 104 may compute the estimated Interchange fees in real-time. For example, the Processor 104 may send information in the financial transaction request (e.g., authorization request information, a consumer's credit and/or debit card information, etc.) to a Real-time Interchange Engine 300 at 364. The Real-time Interchange Engine 300 may be included in the Processor 104 or may be external to the Processor 104. The Real-time Interchange Engine 300 may calculate the estimated Interchange fees in accordance with any industry accepted manner based on the financial transaction information and/or the Issuing Bank 110 response. The Processor 104 may store the estimated Interchange program and/or transaction cost with merchant and financial transaction information in a Database 302 at 370. For example, the information stored in the Database 302 may be sent via the Real-time Interchange Engine 300. The Database 302 may be inside and/or external to Processor 104.

According to an embodiment, the Processor 104 may compute the estimated Interchange fees based on the authorization request response. For example, the authorization request response may include an indication of whether the Issuing Bank 110 approved or declined the authorization request. The Processor 104 may calculate estimated Interchange fees if the authorization request is approved by the Issuing Bank 110, but may not calculate estimated Interchange fees if the authorization request is declined.

The Processor 104 may send the authorization request response to the Merchant 102 at 366. The Processor 104 may send the estimated Interchange fees to Merchant 102 at 368. The authorization request response and the estimated Interchange fees may be sent to the Merchant 102 in the same, or separate, communications for example. If approved, the Consumer 100 may receive the desired goods and/or services from Merchant 102 at 372.

In an embodiment, to obtain an estimated Interchange cost of a potential transaction without the intention of authorizing or settling any transaction, the Merchant 102 may send the Consumer's 100 card payment information in the financial transaction information that is sent to the Processor 104. This may enable the Merchant 102 to request an estimated Interchange fee without any request to the Card Network 108 and/or Issuing Bank 110. The Processor 104 may compute the estimated Interchange fees in the Real-time Interchange Engine 300. The computation of the estimated Interchange fees may be performed without any authorization from the Issuing Bank 110. The Processor 104 may send the estimated Interchange fees to Merchant 102 in response to the request, and may store the estimated Interchange program and transaction cost with merchant and transaction information in the Database 302. The transaction may not be included in the Batch Settlement Process or any process that would place a hold on or move any funds to or from the Consumer's 100 card account.

In other embodiments, the Interchange fee calculation may take place anywhere between the Merchant 102 and the Issuing Bank 110.

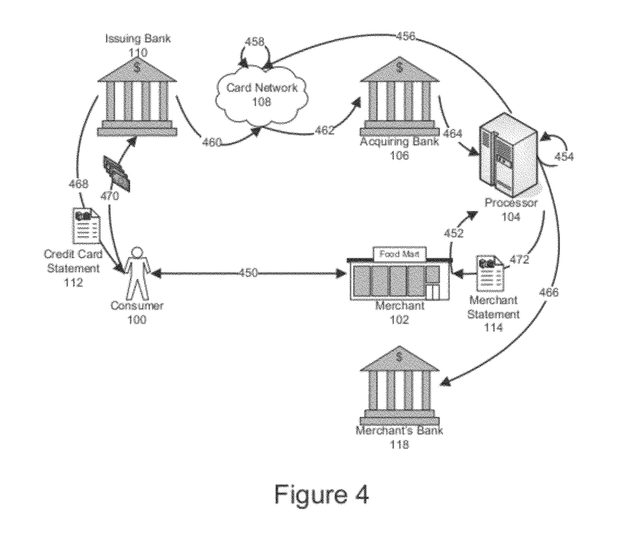

FIG. 4 illustrates an exemplary batch settlement process. As shown, a Consumer 100 makes a purchase at Merchant 102 and receives goods and/or services at 450. At 452, the Merchant 102 may send a settlement file to the Processor 104. For example, the Merchant 102 may send the settlement file to the Processor 104 at certain points in the day. The Processor 104 may compute the estimated Interchange categories and/or costs at 454. At 456, the Processor 104 may send the settlement file to the Card Network 108. The Card Network 108 may compute the actual Interchange category and/or cost at 458. At 460, the Card Network 108 may draw settlement funds less the actual Interchange fees from the Issuing Bank 110. The Card Network 108 may send the settlement funds less the actual Interchange fees to the Acquiring Bank 106 at 462. At 464, the Processor 104 may draw the settlement funds less the actual Interchange fees and/or acquiring fees from the Acquiring Bank 106. The Processor 104 may send the settlement funds less the actual Interchange and/or acquiring fees to the Merchant's Bank 118 at 466. The Consumer 100 may receive a Credit Card Statement 112 (e.g., monthly) from the Issuing Bank 110 at 468, and the Consumer 100 may pay the amount on the Credit Card Statement 112 to the Issuing Bank 110 at 470. The Merchant 102 may receive a Merchant Statement 114 (e.g., monthly) from the Processor 104 at 472. The Merchant Statement 114 may include the details of the Interchange fees that the Merchant had to pay. In one example, the Merchant Statement 114 may be received a relatively long period of time after a financial transaction has occurred.

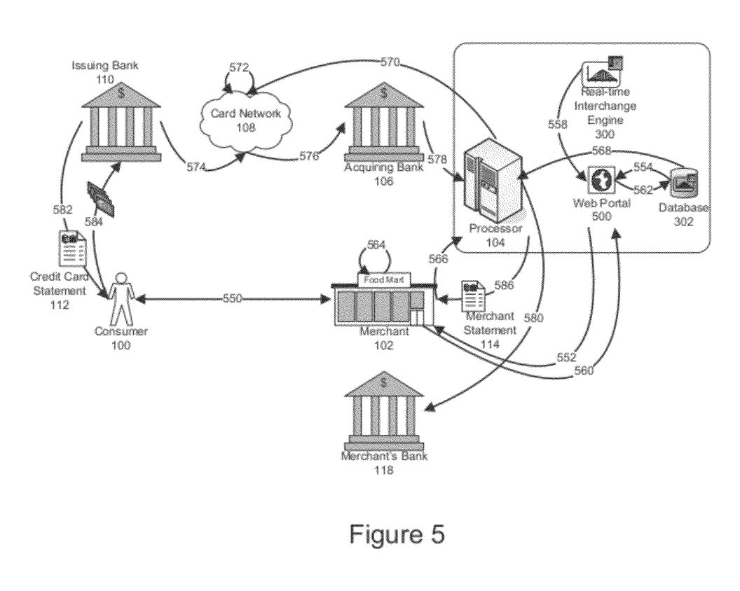

FIG. 5 illustrates an embodiment of a batch settlement process in which a Merchant may be provided with estimated Interchange fees. As illustrated in FIG. 5, at 550, a Consumer 100 may complete a purchase at Merchant 102 and receive goods and/or services. Merchant 102 may review transaction and/or Interchange information (e.g., estimated and/or actual Interchange fees, updated Interchange fees, estimated and/or actual Interchange category, etc.) through Web Portal 500 at 552. For example, the Web Portal 500 may draw transaction and/or Interchange information from Database 302 at 554. The Merchant 102 may review individual transaction and/or Interchange information details prior to or after settlement through the Web Portal 500 at 552. In an example embodiment, the Real-time Interchange Engine 300 may calculate in real-time a list of reasons for Interchange category downgrades and/or costs and display the results, at 558, in the Web Portal 500 for viewing by Merchant 102. The transaction and/or Interchange information may be reviewed by Merchant 102 prior to or after settlement.

At 560, the Merchant 102 may review the individual transaction and/or Interchange information detail, through the Web Portal 500, for individual financial transactions prior to or after settlement. The transaction and/or Interchange information may be updated in Database 302 at 562. In an example embodiment, this information may take the form of exported raw data. If transactions and/or Interchange information are reviewed prior to settlement, the Merchant 102 may have the opportunity to supply additional and/or updated information at 560. For example, the additional and/or updated information may be provided for unsettled transactions to improve the estimated Interchange qualification and the associated fees. The Real-time Interchange Engine 300 may use the additional and/or updated information to calculate an updated Interchange qualification and/or associated fees. Regardless of when the Merchant 102 reviews the information, the Merchant 102 may have the opportunity to change their merchant setup information or make changes to their own business practices at 564 to update and/or improve the estimated Interchange qualification and the associated fees.

The Merchant 102 may send a settlement file to Processor 104 at 566 to initiate the settlement process. The Processor 104 may compute estimated Interchange category and cost.

The Processor 104 may use pre-computed estimated Interchange categories and/or costs to build a file of settlement data. The pre-computed estimated Interchange categories and/or costs may be retrieved from Database 302 at 568. The Processor 104 may send a settlement file to Card Network 108 at 570, where the actual Interchange category and/or costs may be computed at 572. The estimated Interchange category and/or costs may be representative of the actual Interchange category and/or costs. Based on the actual Interchange category, actual Interchange costs, and/or the transaction amounts, the Card Network 108 may draw settlement funds less actual Interchange from the Consumer's 100 Issuing Bank 110 at 574, and may send those settlement funds less Interchange to the Merchant's Acquiring Bank 106 at 576. At 578, the Processor 104 may draw those settlement funds less actual Interchange and/or acquiring fees from the Merchant's Acquiring Bank 106, and at 580 may send those settlement funds less Interchange, acquiring fees, and/or processing fees to the Merchant's Bank 118.

At 582, the Consumer 100 may receive their Credit Card Statement 112 (e.g., monthly) from Issuing Bank 110, and may pay it at 584. At 586, the Merchant 102 may receive their Merchant Statement 114 (e.g., monthly) from their Processor 104, which may include Interchange fee summary and/or detail information, and may pay any balance to the Processor 104.

The embodiments described herein may be provided as a service, such as to other service providers to provide their merchants with estimated Interchange values as part of a real-time authorization response for example. Other payment service providers may include Gateways, Front-End Processors, and/or Back-End Processors. Again, these entities may comprise computer systems, devices, and other equipment to perform the functions of the entity.

Gateways may connect Merchants 102 to an entity that may be a Front-End connection to the Card Network 108. Gateways may take payment data from a variety of sources (e.g., terminals, web sites, payment applications, etc.) and/or may distribute the payment data to various Front-End connections.

Front-End Processors may be entities that may facilitate the authorization portion of the transaction lifecycle to entities with Card Network 108 connectivity (e.g., a Back-End Processor). In another example, Front-End Processors may have direct connectivity to Card Network 108.

Back-End Processors may be entities that may facilitate the settlement of funds from the Consumer's 100 Issuing Bank 110 to the Merchant's Bank 118. For example, Back-End Processors may facilitate the settlement of funds through the Card Network's 108 Interchange system.

The embodiments described herein may be used to test existing transactions and/or qualifications. For example, the embodiments described herein may be made available to prospective merchants to take existing transaction information and/or request estimated Interchange qualifications. This may allow these prospective merchants to directly compare their existing processing costs to what they would be charged using this system, as well as determine any changes that may be made to business practices or transaction data.

The disclosed embodiments may be comprised of financial transaction responses with various data fields relating to Interchange. The responses may be delivered to the merchant in real-time. In another embodiment, the responses may be delivered to the merchant by exporting data at a later date.

In an embodiment, a financial transaction response to a merchant may include a field that signifies the name of the estimated Interchange category and/or program. For example, the name of an estimated Interchange category may be “Business Core T&E Rate I.” The financial transaction response may include a field that signifies an identifier of the estimated Interchange category and/or program that relates back to a textual description of the estimated Interchange category and/or program. For example, the identifier of the estimated Interchange category and/or program may be “US558,” which may relate back to the textual description “Business Core T&E Rate I.”

In an embodiment, a financial transaction response to a merchant may include a field that signifies the estimated Interchange fee based on the transaction amount and/or the estimated Interchange category. For example, the transaction response may include an Interchange percentage field, an Interchange per transaction fee field, and/or an Interchange transaction cost field. The Interchange percentage field may relate to the Interchange category's percentage rate (e.g., “1.8000”) applied to the dollar amount of the transaction. The Interchange per transaction fee field may relate to the Interchange category's fee (e.g., “0.10”) per transaction. The Interchange transaction cost field may relate to a transaction's total Interchange cost (e.g., “1.67”) or the Interchange category's percentage and per transaction fee applied to the transaction.

In an embodiment, a financial transaction response to a merchant may include a date field signifying a period of time in which the estimated qualification is valid. For example, one factor that may affect Interchange qualifications may be how long after a transaction is authorized that the transaction may be settled without qualifying at a lower rate. The risk—and therefore Interchange costs—may increase as the time between a transaction's authorization and settlement date grows. The date field in the transaction response may indicate a date through which the estimated Interchange qualification is valid. This information may be used by merchants as an indicator of possible changes that may be made to their business practices to reduce Interchange costs. As an example, a merchant may ship a product four days after authorization and the valid through date field may indicate a date that is two days after the authorization. This may indicate to the merchant that the transaction may be settled sooner to receive the estimated Interchange rate. This may indicate changes that may be made to the merchant's business practices, in this case by shipping sooner.

In an embodiment, a financial transaction response to a merchant may include verbose settings to influence response contents. For example, a field may be included in the transaction request that signifies the merchant's desire to send additional fields back in the response that may not otherwise be sent.

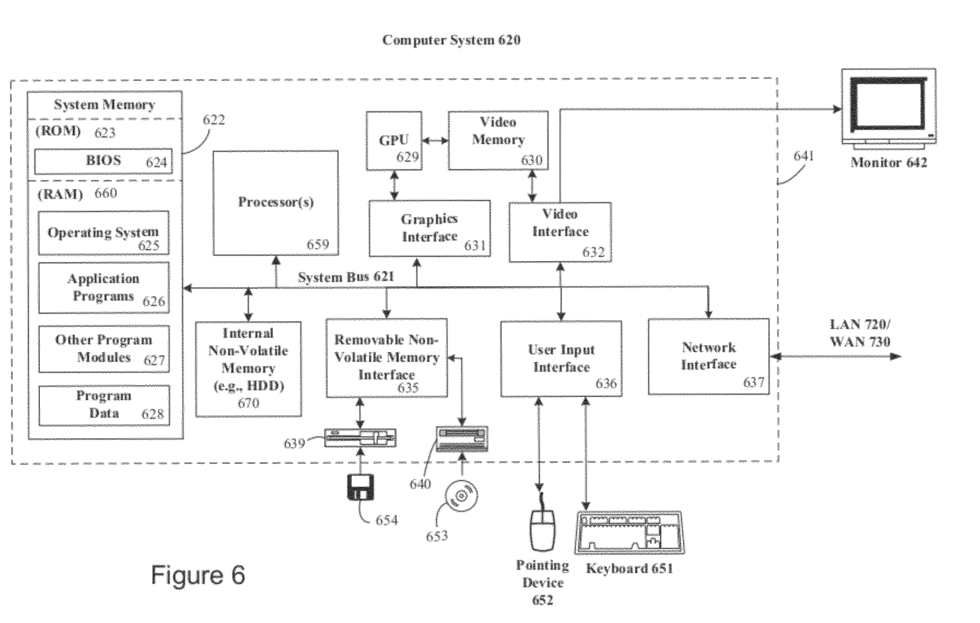

FIG. 6 is a block diagram of an example computer system 620 on which the embodiments described herein and/or various components thereof may be implemented. For example, the functions performed by the entities described in the various embodiments above may be performed by one or more such example computer systems. For example, the Processor 104, Real-time Interchange Engine 300, Database 302, and Web Portal 500 may all be implemented in software (i.e., computer executable instructions or program code) executing on one or more such computer systems 620. It is understood, however, that the computer system 620 is just one example of a suitable computing environment and is not intended to suggest any limitation as to the scope of use or functionality of the presently disclosed subject matter. Neither should the computer system 620 be interpreted as having any dependency or requirement relating to any one or combination of components illustrated in FIG. 6. In some embodiments, the various depicted computing elements may include modules or components configured to instantiate specific aspects of the present disclosure. For example, the terms “module” or “component” used in this description may include specialized hardware components configured to perform function(s) by firmware or switches. In other example embodiments, the terms “module” and “component” may include a general purpose processor, memory, etc., configured by software instructions that embody logic operable to perform function(s). In example embodiments where modules or components include a combination of hardware and software, an implementer may write source code embodying logic and the source code may be compiled into machine readable code that can be processed by the general purpose processor. Since the state of the art has evolved to a point where there is little difference between hardware, software, or a combination of hardware/software, the selection of hardware versus software to effectuate specific functions is a design choice left to an implementer. More specifically, a software process may be transformed into an equivalent hardware structure, and a hardware structure may itself be transformed into an equivalent software process. Thus, the selection of a hardware implementation versus a software implementation is one of design choice and left to the implementer.

In FIG. 6, the computer system 620 comprises a computer 641, which may include a variety of computer readable media. Computer readable media may be available media that may be accessed by computer 641 and may include volatile and/or nonvolatile media, removable and/or non-removable media. The system memory 622 may include computer storage media in the form of volatile and/or nonvolatile memory such as read only memory (ROM) 623 and random access memory (RAM) 660. A basic input/output system 624 (BIOS), containing the basic routines that help to transfer information between elements within computer 641, such as during start-up, may be stored in ROM 623. RAM 660 may contain data and/or program modules that are immediately accessible to and/or presently being operated on by processing unit 659. By way of example, and not limitation, FIG. 6 illustrates operating system 625, application programs 626, other program modules 627, and program data 628. As a further example, financial transaction information and/or Interchange fee information may, in one embodiment, be stored in the system memory 622, as well as in any of a variety of non-volatile memory media discussed herein.

The computer 641 may also include other removable/non-removable, volatile/nonvolatile computer storage media. By way of example, the computer 641 may include a hard disk drive 670 that reads from or writes to non-removable, nonvolatile magnetic media, a magnetic disk drive 639 that reads from or writes to a removable, nonvolatile magnetic disk 654, and an optical disk drive 640 that reads from or writes to a removable, nonvolatile optical disk 653 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. Magnetic disk drive 639 and optical disk drive 640 may be connected to the system bus 621 by a removable memory interface, such as interface 635. The drives and their associated computer storage media discussed herein, and illustrated in FIG. 6, may provide storage of computer readable instructions, data structures, program modules and other data for the computer 641.

A user may enter commands and information into the computer 641 through input devices such as a keyboard 651 and/or pointing device 652, commonly referred to as a mouse, trackball, or touch pad. Other input devices (not shown) may include a microphone, joystick, game pad, satellite dish, scanner, or the like. These and other input devices may be connected to the processing unit 659 through a user input interface 636 that is coupled to the system bus, but may be connected by other interface and/or bus structures, such as a parallel port, game port, or a universal serial bus (USB) for example. The computer may connect to a local area network or wide area network, such as LAN 720 and/or WAN 730, through a network interface or adapter 637.

As is apparent from the embodiments described herein, all or portions of the various systems, methods, and aspects of the present invention may be embodied in hardware, software, or a combination of both. When embodied in software, the methods and apparatus of the present invention, or certain aspects or portions thereof, may be embodied in the form of program code (i.e., computer executable instructions). This program code may be stored on a computer-readable storage medium, such as a magnetic, electrical, or optical storage medium, including without limitation a floppy diskette, CD-ROM, CD-RW, DVD-ROM, DVD-RAM, magnetic tape, flash memory, hard disk drive, or any other machine-readable storage medium, wherein, when the program code is loaded into and executed by a machine, such as a computer or server, the machine becomes an apparatus for practicing the invention. A computer on which the program code executes may include a processor, a storage medium readable by the processor (including volatile and/or non-volatile memory and/or storage elements), at least one input device, and/or at least one output device. The program code may be implemented in a high level procedural or object oriented programming language. Alternatively, the program code may be implemented in an assembly or machine language. In any case, the language may be a compiled or interpreted language. When implemented on a general-purpose processor, the program code may combine with the processor to provide a unique apparatus that operates analogously to specific logic circuits. As used herein, the terms “computer-readable medium” and “computer-readable storage medium” do not include a signal.

As the foregoing illustrates, the present invention is directed to systems, methods, and apparatus for providing estimated Interchange fees associated with a financial transaction. Changes may be made to the embodiments described above without departing from the broad inventive concepts thereof. Accordingly, the present invention is not limited to the particular embodiments disclosed, but is intended to cover all modifications that are within the spirit and scope of the invention as defined by the appended claims.

What is claimed:

1. A computer-implemented method for providing a merchant with an estimated Interchange fee in real-time, the method comprising:
receiving, at a computer system, a financial transaction request from the merchant;
determining, by the computer system, the estimated Interchange fee in real-time based on the received financial transaction request, wherein the estimated Interchange fee is representative of an actual Interchange fee associated with a financial transaction; and
sending, by the computer system, the estimated Interchange fee to the merchant.

2. The method of claim 1, further comprising the following additional steps performed by the computer system:
sending an authorization request associated with the financial transaction to a card network;
receiving an authorization response associated with the financial transaction from the card network; and
sending the authorization response to the merchant.

3. The method of claim 2, wherein the estimated Interchange fee is determined when the authorization response indicates an approval associated with the financial transaction.

4. The method of claim 3, wherein the authorization response and the estimated Interchange fee are sent to the merchant in a same communication.

5. The method of claim 1, wherein the estimated Interchange fee is sent to the merchant in real-time via a financial transaction response.

6. The method of claim 5, wherein the financial transaction response further comprises Interchange information other than the Interchange fee.

7. The method of claim 6, wherein the Interchange information indicates at least one of an Interchange percentage, an Interchange per transaction fee, an Interchange transaction cost, an estimated Interchange category name, an estimated Interchange category identifier, a verbose setting to influence response contents, or a period of time that an estimated qualification for the Interchange fee is valid.

8. The method of claim 1, wherein the method is performed as a service to a payment service provider.

9. The method of claim 8, wherein the payment service provider comprises at least one of a gateway, a front-end processor, or a back-end processor.

10. The method of claim 1, wherein the estimated Interchange fee is sent to the merchant via a web portal.

11. The method of claim 1, wherein the estimated Interchange fee is sent to the merchant via a data export.

12. The method of claim 1, wherein the financial transaction request comprises an authorization request.

13. The method of claim 1, wherein the financial transaction request comprises a consumer's credit card information.

14. The method of claim 1, further comprising the following additional steps performed by the computer system:
receiving a settlement file from the merchant, the settlement file including data associated with the financial transaction;
determining an updated Interchange fee in real-time based on the data associated with the financial transaction; and
sending the updated Interchange fee to the merchant.

15. A computer-readable storage medium, the computer-readable medium having computer executable instructions stored thereon that are configured to cause a computer system to perform the following steps when executed:
receive a financial transaction request from a merchant;
determine an estimated Interchange fee in real-time based on the received financial transaction request, wherein the estimated Interchange fee is representative of an actual Interchange fee associated with a financial transaction; and
send the estimated Interchange fee to the merchant.

16. The computer-readable storage medium of claim 15, wherein the computer-executable instructions are further configured to cause a computer system to perform the following steps when executed:
send an authorization request associated with the financial transaction to a card network;
receive an authorization response associated with the financial transaction from the card network; and
send the authorization response to the merchant.

17. The computer-readable storage medium of claim 16, wherein the estimated Interchange fee is determined when the authorization response indicates an approval associated with the financial transaction.

18. The computer-readable storage medium of claim 17, wherein the authorization response and the estimated Interchange fee are sent to the merchant in a same communication.

19. The computer-readable storage medium of claim 15, wherein the estimated Interchange fee is sent to the merchant in real-time via a financial transaction response,

20. The computer-readable storage medium of claim 19, wherein the financial transaction response comprises Interchange information other than the Interchange fee.

21. The computer-readable storage medium of claim 20, wherein the Interchange information indicates at least one of an Interchange percentage, an Interchange per transaction fee, an Interchange transaction cost, an estimated Interchange category name, an estimated Interchange category identifier, a verbose setting to influence response contents, or a period of time that an estimated qualification for the Interchange fee is valid.

22. The computer-readable storage medium of claim 15, wherein the computer-executable instructions are further configured to cause a computer system to perform the following steps:
receive a settlement file from the merchant, the settlement file including data associated with the financial transaction;
determine an updated Interchange fee in real-time based on the data associated with the financial transaction; and
send the updated Interchange fee to the merchant in real-time.
